(19) United States
(12) Patent Application Publication
(10) Pub. No.: US 2008/0143709 A1
(43) Pub. Date: Jun. 19, 2008

(54) System and method for accessing three dimensional information from a panoramic image

(75) Inventors: Donn Anthony Fassero, San Francisco, CA (US); John Ristevski, San Francisco, CA (US)

Correspondence Address: DLA PIPER US LLP, 2000 UNIVERSITY AVENUE, E. PALO ALTO, CA, 94303-2248, US

(73) Assignee: Earthmine, Inc.

(21) Appl. No.: 11/639,777

(22) Filed: Dec. 14, 2006

(51) Int. Cl. G06T 15/00

(52) U.S. Cl. 345/419

(57) ABSTRACT

The proposed invention defines a system and methods for accessing and displaying three dimensional data through a panoramic image. Three dimensional data comprised of points and polygons is stored in a spatial database on a server and is delivered to the client on demand through point or area selections defined in a panoramic image viewer in the 2D spherical coordinate system of the panoramic image. A number of different processes are defined for transforming these two dimensional spherical coordinates into a three dimensional coordinate, the result of which is returned to the client and used to update the panoramic image and corresponding map or aerial image in the client side application.

### FIELD OF THE INVENTION

The invention in general relates to the viewing of three dimensional information using a computer and more particularly to a system and a method for retrieving three dimensional data from a panoramic image that is positioned and oriented in three dimensional space.

### BACKGROUND OF THE INVENTION

User interaction with three dimensional data on a computer or computer imaging device with a two dimensional display poses many problems. Some solutions use a series of two dimensional views along major x, y, and z axis such as plans, sections, and elevations, and make interacting with three dimensional navigable through these axial views. A major problem with this solution is that abstracted two dimensional views are unintuitive to how humans perceive three dimensional environments in the real world, making for a high learning curve and a specialized practice.

More recent solutions to interacting with three dimensional data on a computer are programs that let users navigate and visualize three dimensional models made up of points, lines, polygons, and volumes. The viewpoint is not limited to the major x, y, and z axis, and perspective is generated in real time, allowing for a representation of three dimensions that is very similar to how humans perceive three dimensional environments in the real world. A major problem with this solution is that navigating three dimensional data with standard input devices, such as a mouse and keyboard, require complex combinations of inputs to control the increased degrees of freedom. The learning curve for using such solutions remains high especially for people with little or no experience working with a mouse or keyboard to control interaction within a three dimensional environment.

A problem inherent in solutions that use a computer to interact with three dimensional data is that the data used for visualization is abstracted to a series of points, lines, polygons, and volumes that do not exist as such in real world environments. Some attempted solutions utilize photographic texturing or coloring of the abstracted geometric points, lines, polygons, and volumes to add realistic coloring to the abstracted data. The problem with this solution is that the level of detail for the geometric data, as well as the photographic texturing or coloring, requires a large amount of processing power to make the experience realistic to human perception. Typically, such views cannot be rendered in real time, and require rendering along predefined paths.

Another problem inherent in solutions that use a computer to interact with three dimensional data is the ability to do so over a network connection involving multiple computers. Some solutions require that the data be downloaded completely from the server before interacting with the data on a client side application. A problem with these solutions is that the client side application requires a large amount of processing power to interact with realistic three dimensional data in real time. Other solutions involve the client side user to download an application that can process three dimensional data that is sent dynamically from a server over a network connection. Problems with this solution are that a large amount of network bandwidth is needed to stream realistic three dimensional data, as well as a large amount of processing power on the client side to interact with the data. Reduced bandwidth environments such as cellular networks and wireless networks make it difficult to access three dimensional data. Likewise reduced processing power on a mobile device makes it difficult to interact with three dimensional data once it has been download to the client.

A problem with current two and three dimensional geo-coded information is that the data is almost always represented as a single point, line, or multiple lines, making it difficult to understand as a real world location. An example of popular geo-coded information are home or business addresses, where a two or three dimensional coordinate is used to represent a three dimensional volume of a building or structure located at a specific latitude, longitude, elevation, or street intersection. One existing solution involves geographically referenced imagery from the air or ground to display the coordinate within the context of the image. A problem with this solution is that the imagery has a narrow field of view, lacking the immersive three dimensional experience provided by a panoramic image. Another emerging solution to displaying existing two and three dimensional geo-coded information are constructed three dimensional models that can be navigated in real-time to show a representative volume of a building located at a specific address. Although this solution provides an immersive three dimensional experience, it requires detailed and photographically textured models that require high bandwidth, client side processing power, skilled user navigation, and lack the detail and resolution necessary to distinguish the geo-coded address among similar looking volumes nearby.

A solution is needed for interacting with three dimensional data on a computer even when the computer has limited network bandwidth and limited computer processing power. The solution may also simplify the navigation to reduce the learning curve for users wishing to interact with three dimensional data. The solution may also be used for interacting with existing two and three dimensional data collected or generated outside the proposed system and method. The solution may also provide three dimensional data that appears to the user as realistic as possible.

### SUMMARY

A system and method for accessing two and three dimensional information from a panoramic image is provided. The system provides a streamlined low bandwidth solution to the delivery of two and three dimensional data when the data is being communicated over a network from a first computer to a second computer. In one exemplary embodiment of the system using a client/server architecture, the first computer may be a computing device that executes a client application and the second computer may be a server that is coupled to the computing device over a network such as the Internet. Thus, in this exemplary embodiment, the two and three dimensional data is delivered over the network from the server to the client application. The system also addresses issues with the presentation and navigation of two and three dimensional information by allowing the user to “interface” with the data through panoramic images. The user selections, such as points in the panoramic image, are defined in the two dimensional coordinate system of the panoramic image and are translated to three dimensional coordinates through a number of processes. In the exemplary client/server architecture embodiment, the user selections are translated at the server into three dimensional coordinates and then the results are transmitted back to the client application over the network.

In the exemplary embodiment of the system, the system uses a network client/server architecture where a computer image viewer displaying a panoramic image exists on a first computing device (a client side) and is connected through a network to a spatial database containing two and three dimensional data on a second computing device (a server side). Panoramic images are sent from the server over a network to the client viewer and are displayed through a panoramic image viewer. The two dimensional panoramic images are corrected to display a portion of the total field of view of the image. The user can navigate to any desired portion within the panoramic image by using a computer input device to rotate a “virtual camera” and have the results display in real time through the computer image viewer. The system solves the problem of interacting with two and three dimensional data by using two dimensional panoramic images that represent three dimensional spaces. The panoramic image provides a more realistic and intuitive interface to two and three dimensional data by giving a seamless real-time representation of three dimensional data that corresponds more closely to the human experience of real world environments.

The system and method allow for various data created outside the system and method, including two and three dimensional geo-coded data, to be accessed through the system and method. The two and three dimensional geo-coded data may be imported into the system or connected to the system locally or over a network. User coordinate selection or keyword entry in the system will display associated two and three dimensional data created outside the system and method and put it in the context of the associated two dimensional panoramic image(s).

The system and method allow users to make selections through two dimensional panoramic images to access over a network, the two and three dimensional data in the system. User selection(s) of two dimensional panoramic image(s) are expressed in two dimensional spherical coordinate(s) and are then translated into three dimensional data. When the system is operated over a network, the system reduces the bandwidth needed to download and view typical two and three dimensional data since only the single data three dimensional data point requested by the user is sent across the network. This reduction in bandwidth makes it feasible for reduced bandwidth networks, such as cellular networks and other wireless networks, to access two and three dimensional data using the system.

### BRIEF DESCRIPTION OF THE DRAWINGS

FIG. 1 illustrates an example of a client/server implementation of a three dimensional information system that includes a computer image viewer on the client side and the spatial database containing two and three dimensional data on the server side;

FIG. 2 is a block diagram illustrating more details of the client/server implementation of the three dimensional information system shown in FIG. 1;

FIGS. 3A, 3B, and 3C are diagrams illustrating database schemas for a database containing points only in a spherical coordinate system, points and polygons in a Cartesian coordinate system, and polygons in a Cartesian coordinate system.

FIG. 4A is a flow diagram depicting a method to transform a text string representing a standard street address into a two or three dimensional coordinate;

FIG. 4B is a flow diagram depicting a method to transform a text string representing a descriptive keyword into a three dimensional coordinate;

FIG. 5A is a flow diagram depicting a method to transform a two dimensional spherical coordinate obtained from a user selected point in the panorama into a three dimensional coordinate utilizing a plurality of three dimensional points contained within the spatial database;

FIG. 5B is a flow diagram depicting an alternate method to transform a two dimensional spherical coordinate obtained from a user selected point in the panorama into a three dimensional coordinate utilizing a plurality of three dimensional points contained within the spatial database;

FIG. 5C is a flow diagram depicting a second alternate method to transform a two dimensional spherical coordinate obtained from a user selected point in the panorama into a three dimensional coordinate utilizing a three dimensional surface model contained within the spatial database;

FIG. 5D is a flow diagram depicting an alternate method to transform a two dimensional spherical coordinate obtained from a user selected point in the panorama into a three dimensional coordinate utilizing a plurality of three dimensional points and a three dimensional surface model contained within the spatial database;

FIG. 6A is a flow diagram depicting a method to transform a two dimensional coordinate obtained from a user selected point in the map viewer into a three dimensional coordinate utilizing a plurality of three dimensional points contained within the spatial database;

FIG. 6B is a flow diagram depicting a method to transform a two dimensional coordinate obtained from a user selected point in the map viewer into a three dimensional coordinate utilizing a plurality of three dimensional polygons contained within the spatial database;

FIG. 6C is a flow diagram depicting a method to transform a two dimensional coordinate obtained from a user selected point in the map viewer into a three dimensional coordinate utilizing a plurality of three dimensional points and polygons contained within the spatial database;

FIG. 7A is a flow diagram depicting an update process to reflect the user selected location;

FIG. 7B is a flow diagram depicting the procedure for updating the map images displayed in the map viewer to reflect the user selected location;

FIG. 7C is a flow diagram depicting the procedure for updating the current panorama and its orientation in the panorama viewer to reflect the user selected location;

FIG. 7D is a flow diagram depicting the procedure for transforming the user selected location into a standardized address string;

FIG. 7E is a flow diagram depicting the procedure for returning tag information that is proximate to the user selected location;

FIG. 8 is a flow diagram depicting a method for user entered tags to be attached to a three dimensional coordinate and saved to the spatial database;

FIGS. 9A-9J depict the process for transforming a two dimensional spherical coordinate obtained from a user selected point in the panorama into a three dimensional coordinate utilizing a three dimensional surface model;

FIG. 10A is an exemplary user interface delivered through a web browser, depicting a panoramic viewer, map viewer and text search box; and

FIG. 10B illustrates how entering information into one of the windows (text box, map viewer, or panorama viewer window) displays results in the other two windows.

### DETAILED DESCRIPTION OF AN EMBODIMENT

The invention is particularly applicable to a web based, software implemented, three dimensional client/server geographic information system and it is in this context that the invention will be described. It will be appreciated, however, that the system and method in accordance with the invention has greater utility, such as to other types of two and three dimensional geographic information systems that use other architectures including stand-alone computer systems, peer to peer computer systems and the like. In addition, the system and method can be implemented in software (as described below in the exemplary embodiment of the system), hardware (with embedded code and functions) or in a combination of hardware and software all of which are within the scope of the invention.

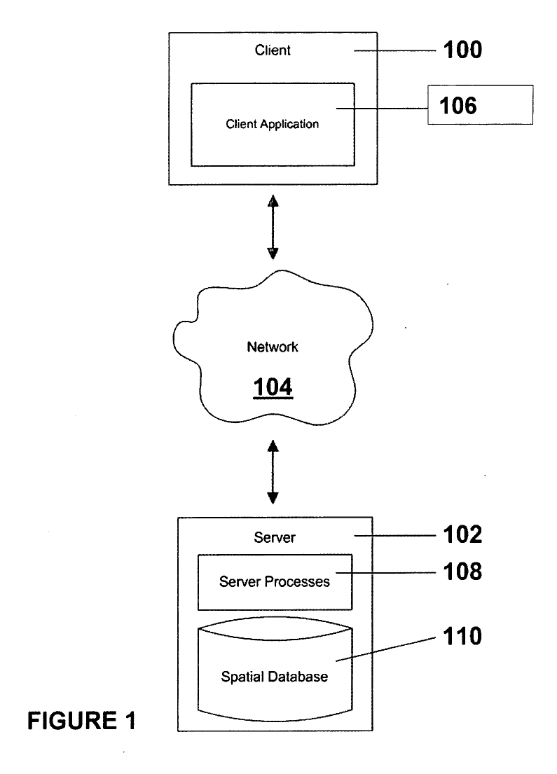

FIG. 1 illustrates an exemplary implementation of the system for accessing two and three dimensional information from a panoramic image in which the system has one or more first computing device(s) 100 and a second computing device 102 coupled to each other (and communicating with each other over a network 104. In a particular exemplary embodiment, the one or more first computing devices may be any processing unit based device with sufficient processing power (a Pentium or equivalent processor), sufficient memory and connectivity to interact with the second computing device, display the images to the user and execute a client application. For example, the first computing device may be a laptop computer, a desktop computer, a PDA such as a Palm device, a wireless email device such as the Blackberry, a mobile phone device or a tablet computer. In a particular exemplary embodiment, the second computing device may be any processing unit based device with sufficient processing power (a Pentium or equivalent processor), sufficient memory and connectivity to interact with the first computing devices and execute the processes and functions of the system described below. For example, the second computing device may be a server computer. The network 104, in the exemplary embodiment, may be any communications or computer networks such as the Internet, the World Wide Web (the Web), a local area network, a wide area network or other communication networks which transmit data using a particular protocol, such as for example HTTP. The network 104 may also be a bus in a computer system when the first and second computing devices are a stand-alone computer. The network may also be a peer-to-peer network when the first and second computing devices are peer computers in a peer-to-peer architecture.

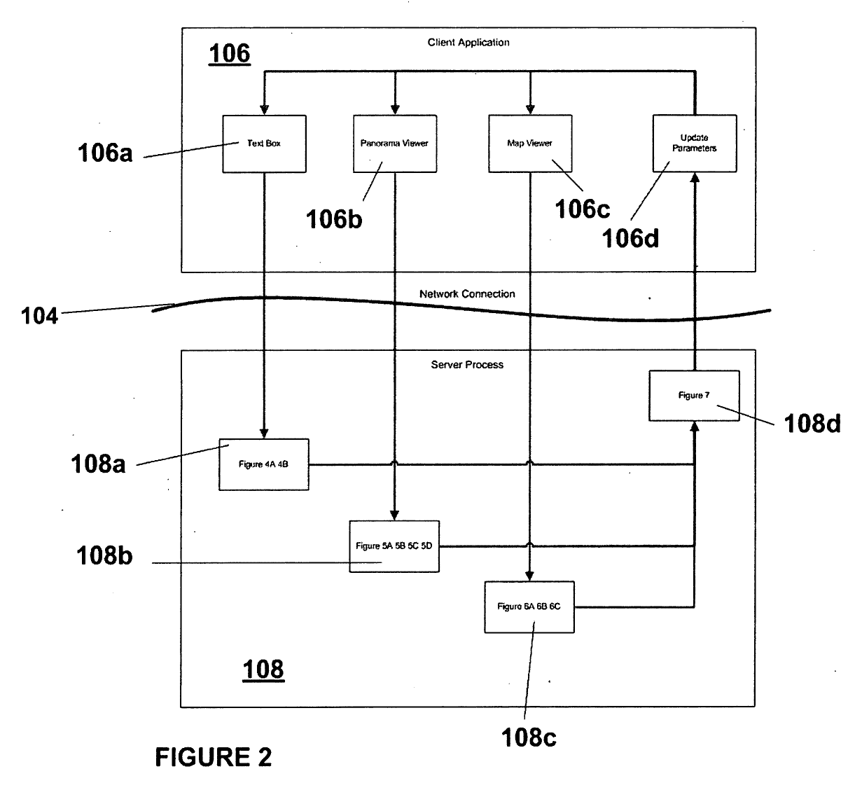

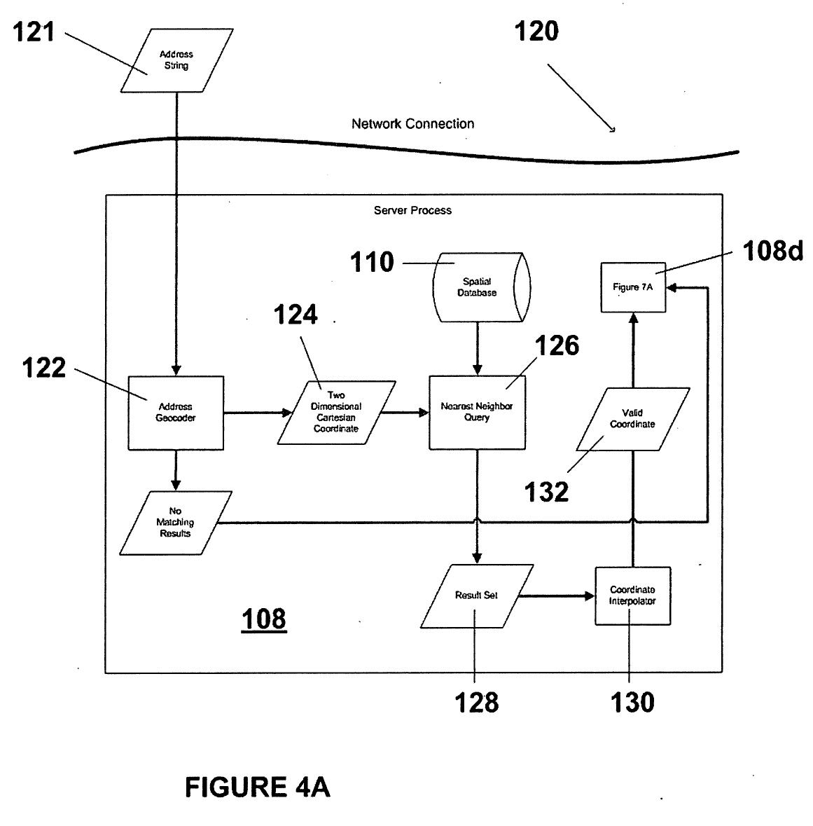

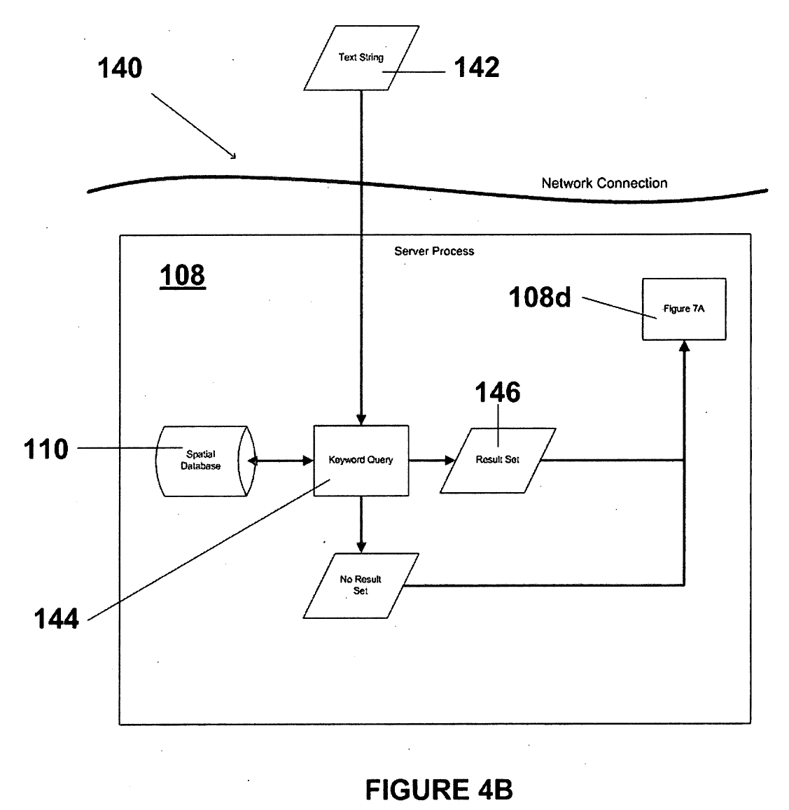

Each first computing device 100, that may be known as a client in the client/server exemplary embodiment that will be used for illustration purposes, may include an application 106 such as a client application which comprises one or more lines of computer code executed by the processing unit of the first computing device to provide the operations and functionality of the client application as shown in FIG. 2. In one exemplary embodiment, the client application may be a software application which can be executed inside a Web Browser which resides on and is executed by the first computing device. The second computing device 102, that may be known as a server in the client server exemplary embodiment that is used herein for illustration purposes, may include a set of processes 108 (described below in more detail with reference to FIGS. 4-7D) and a data store 110, such as a spatial database, that contains two and three dimensional points and other spatial entities such as lines, polygons and volumes. The server processes may include a geocoding algorithm and database for transforming standard address information into two dimensional coordinates. To illustrate the system below, the client/server exemplary embodiment is discussed although the system can be implemented on other systems, such as a stand-alone computer system in which the functions and operations of the first and second computing devices 100, 102 are resident on a single computing device.

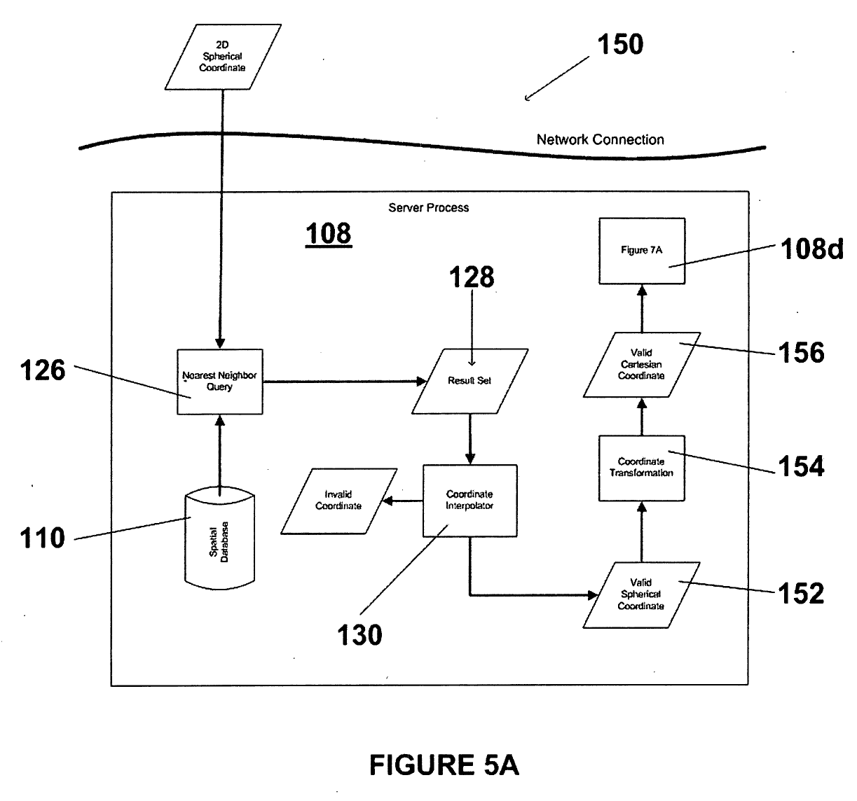

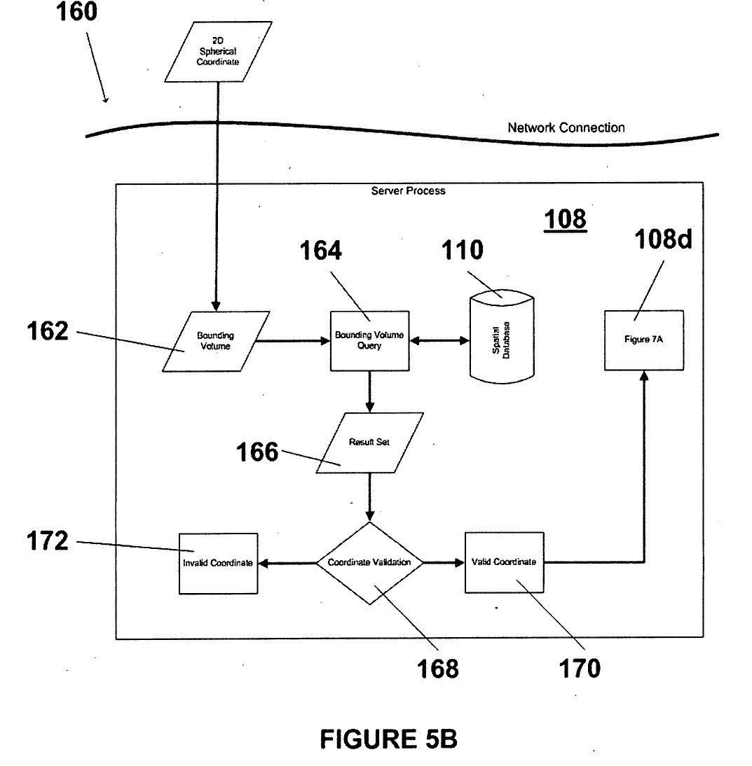

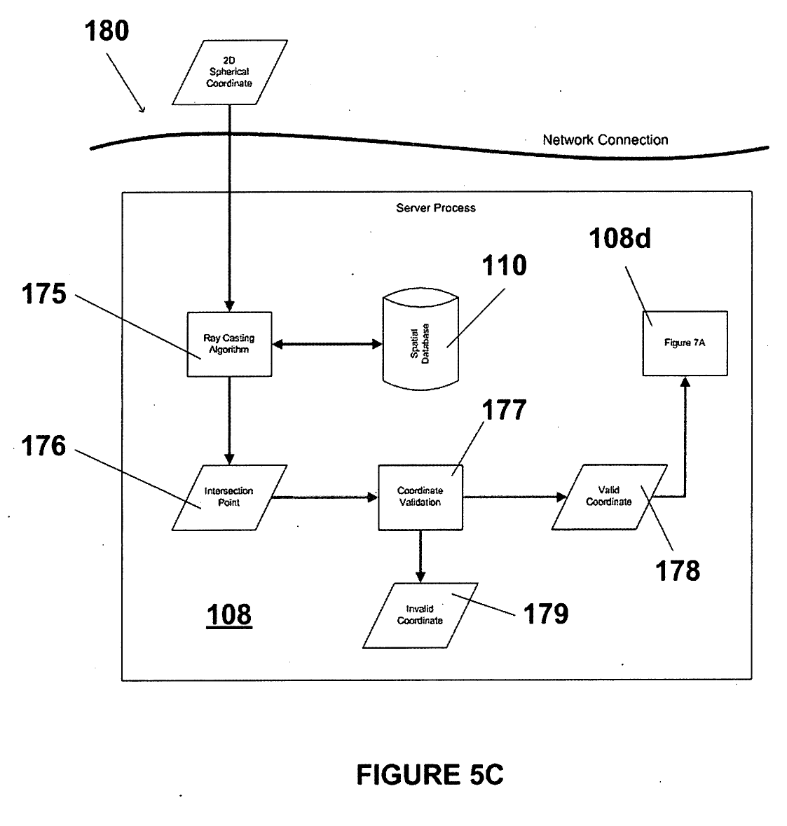

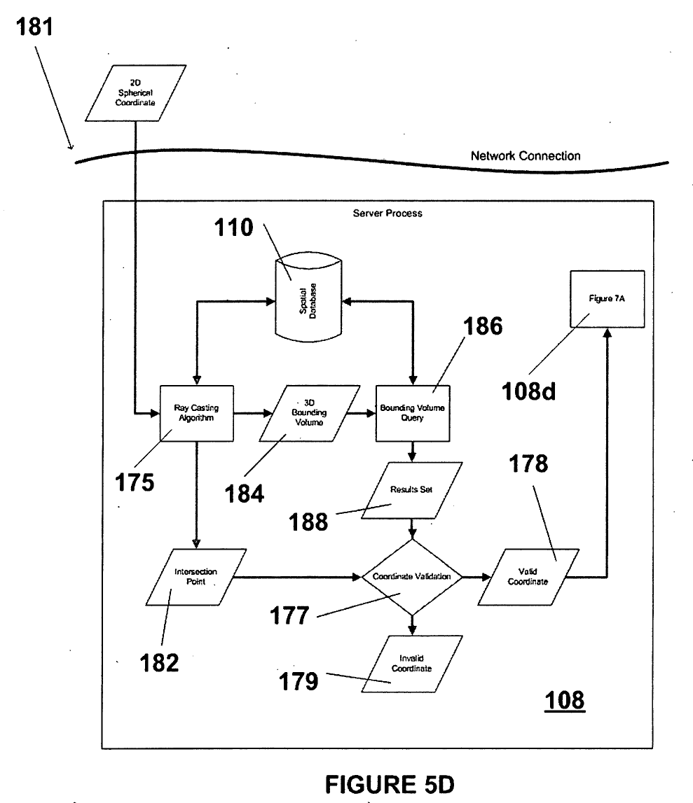

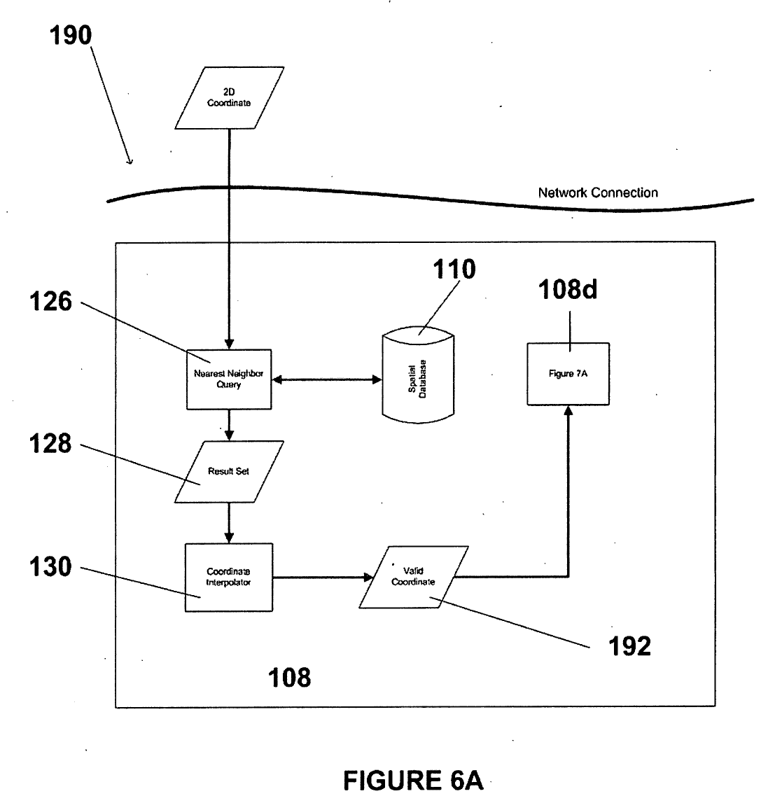

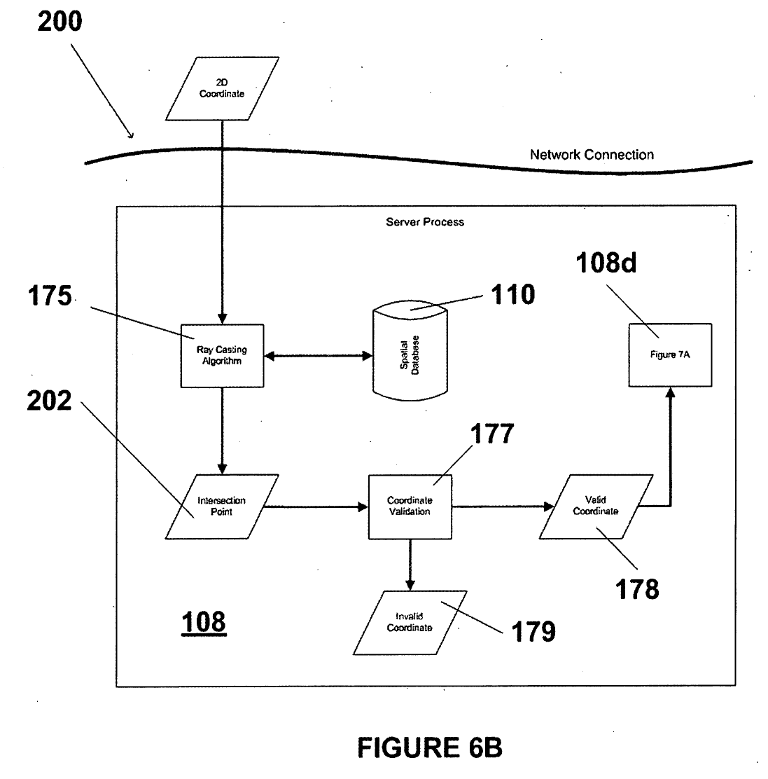

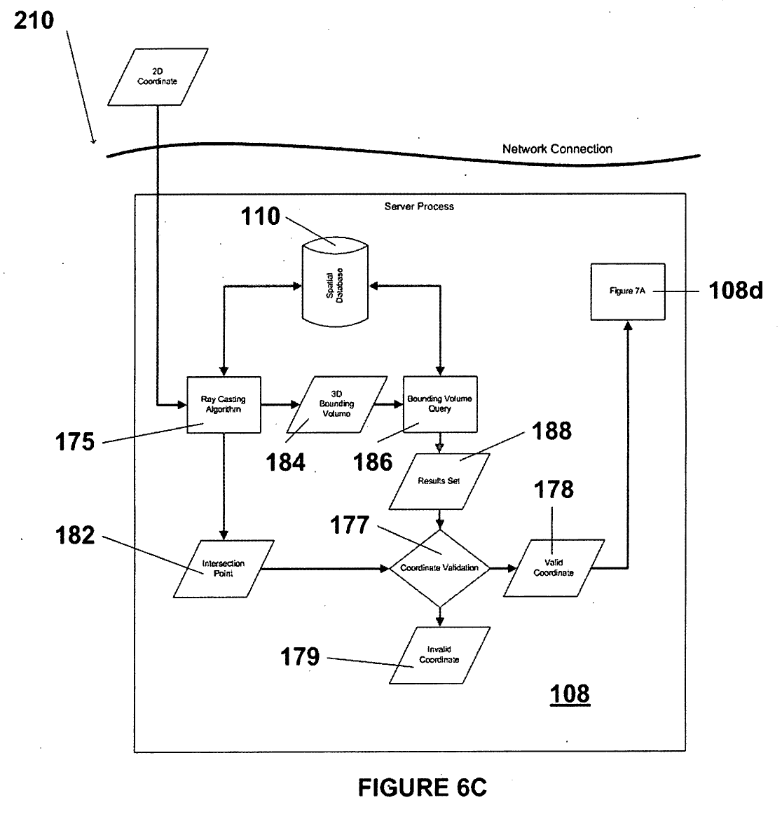

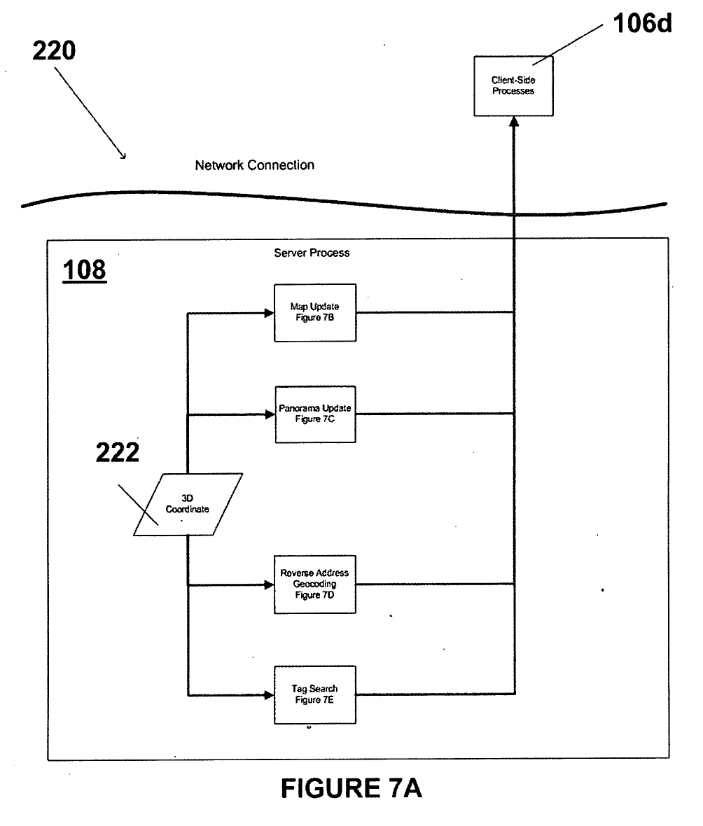

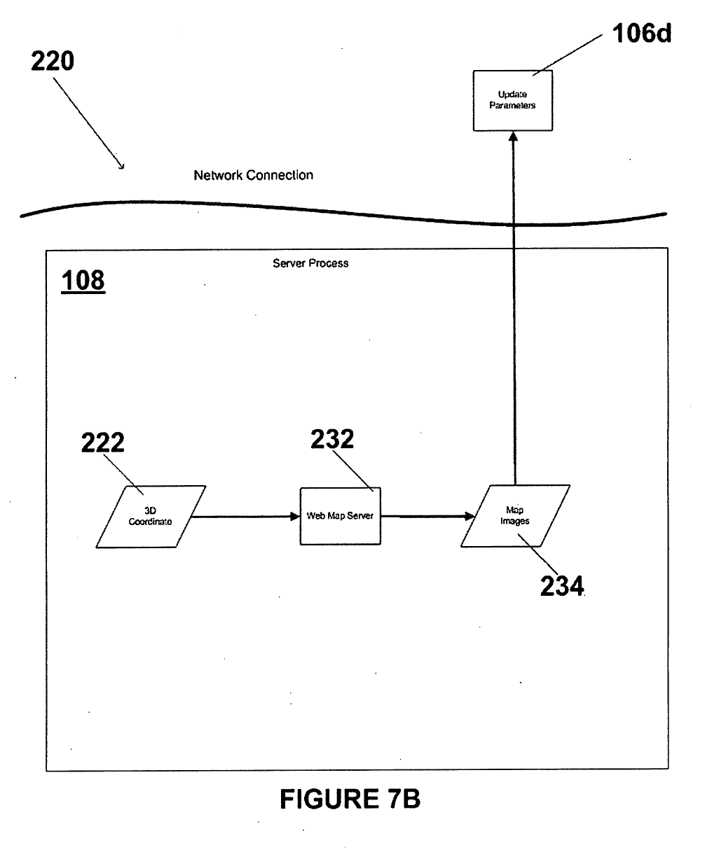

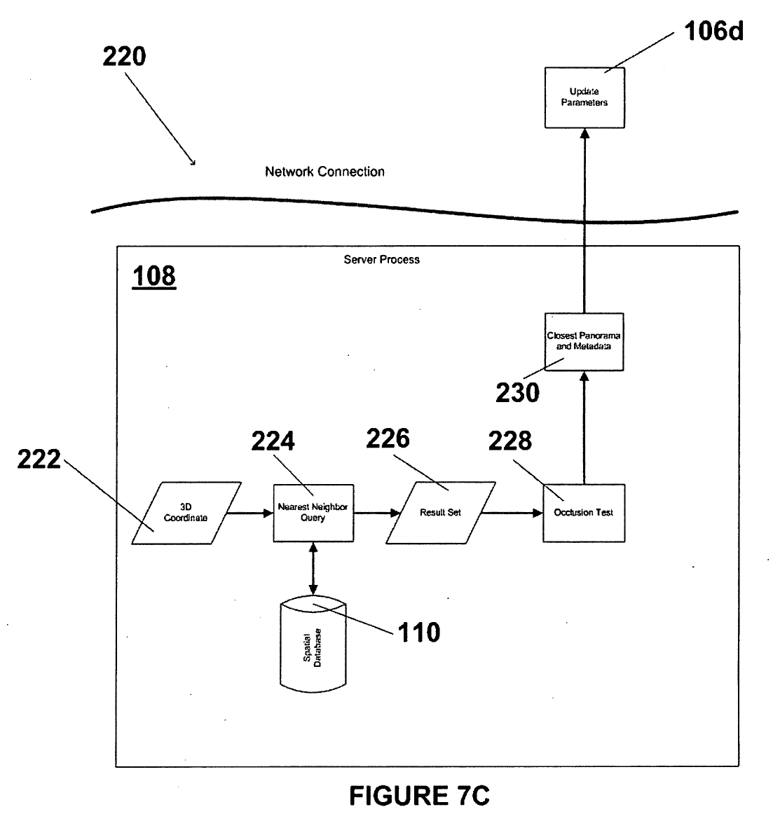

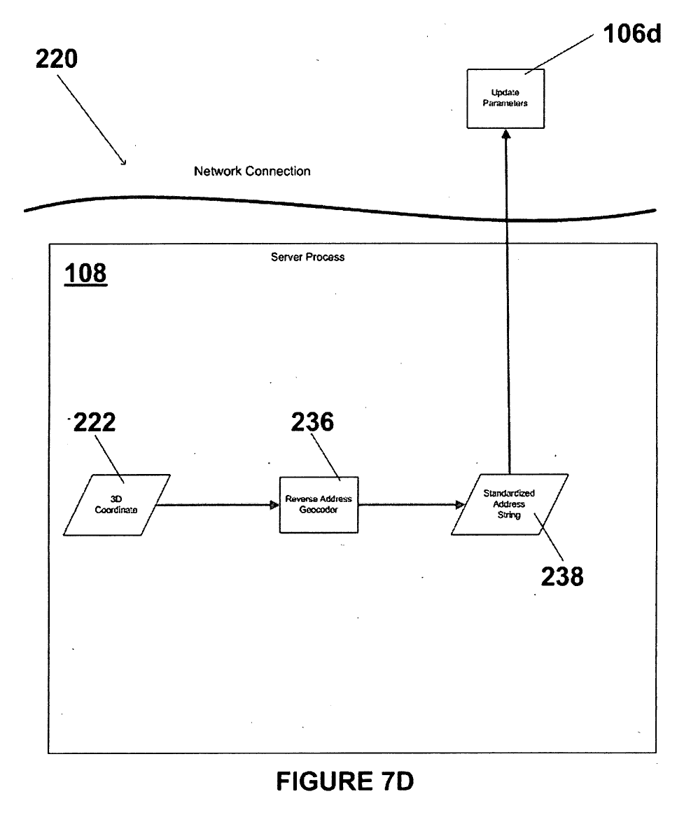

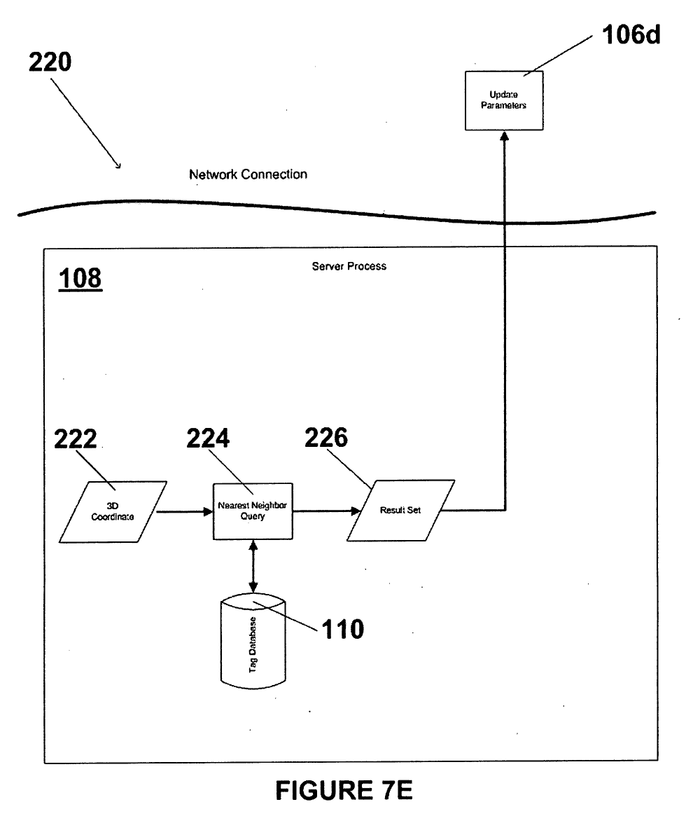

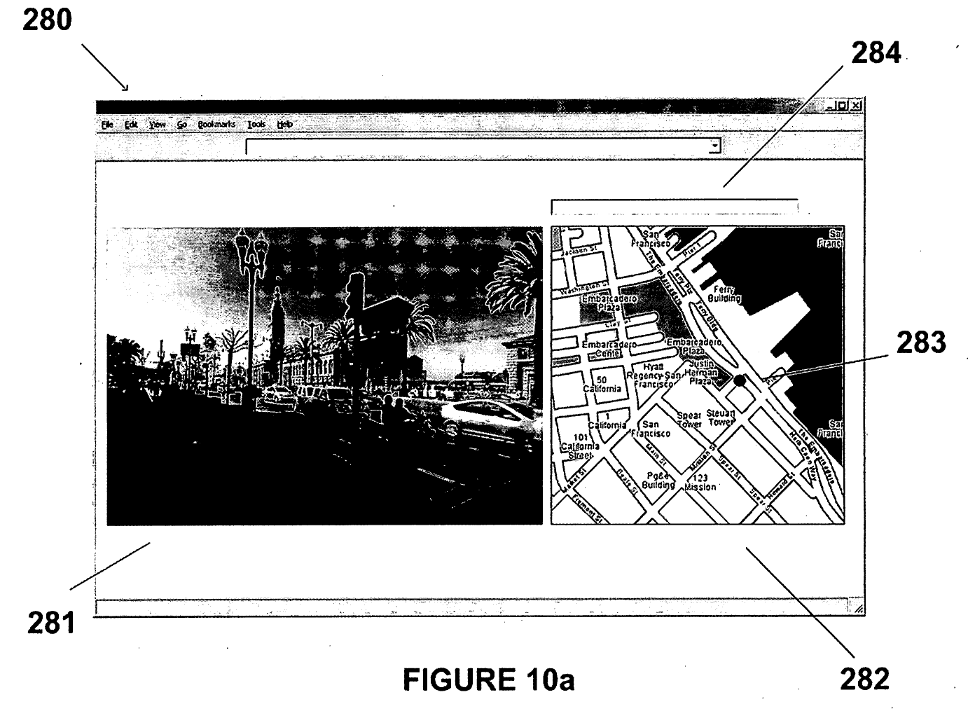

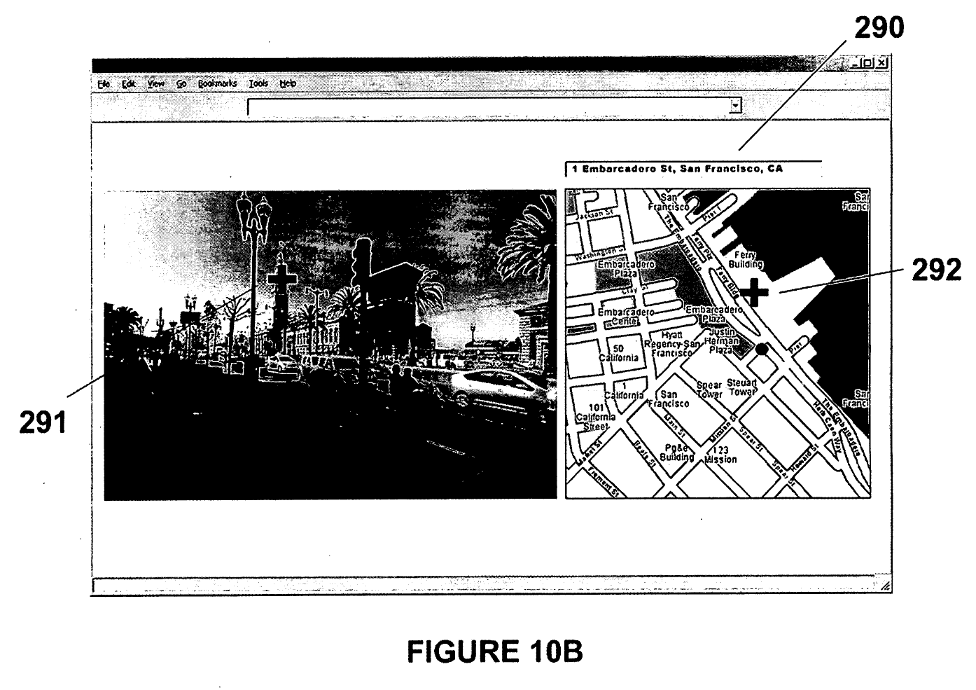

FIG. 2 is a block diagram illustrating more details of the client/server exemplary embodiment and in particular shows more details of the client application 106 on the first computing device and the set of processes 108 on the second computing device. The client application may include a text box process 106a which allows the user to input search terms wherein the search terms may include a text string representing a standard street address or a descriptive keyword. In the exemplary embodiment, these search terms may be transmitted to the server and transformed into one or more three dimensional coordinates using a process 108a that is described in greater detail below with reference to FIGS. 4A and 4B. The client application may further include a panoramic image viewer 106b which enables the user to view manipulate the view direction of a panoramic image and make selections in that image. In the exemplary embodiment, these selections are transformed from screen coordinates into two dimensional spherical coordinates which are transmitted to the server where they are transformed into three dimensional coordinates using a process 108b that is described in greater detail below with reference to FIGS. 5A-5D. The client application may further include a map viewer 106c which enables the user of the first computing device to see a map, aerial or satellite image of a given area and make selections on that map. An exemplary user interface is shown in FIG. 10A where a web browser 280 displays a map viewer 282, the panoramic image viewer 281, the current viewpoint 283, and a text box 284. These selections are transformed from screen coordinates into two dimensional coordinates which are transmitted to the server where they are transformed into three dimensional coordinates using a process 108c that is described in greater detail below with reference to FIGS. 6A-6C. The client application may further include a set of update parameters/processes 106d which receive information from the server (using a process 108d that is described in more detail below with reference to FIG. 7A-e) and update the text box, map and panoramic imager viewers according to user selections.

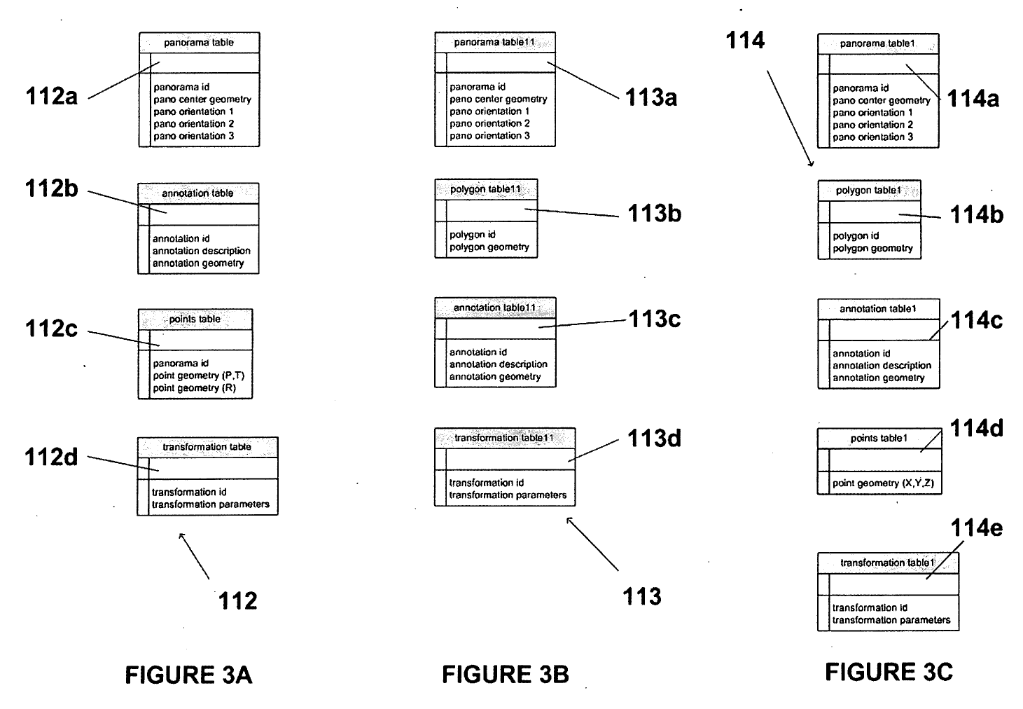

FIGS. 3A, 3B and 3C illustrate database schemas of the data store 110 for a database containing points only stored in a spherical coordinates system format 112, a database containing polygons only stored in a Cartesian coordinate system format 113 and a database containing points and polygons stored in a Cartesian coordinate system format 114. The points only database schema 112 may include a panorama table 112a, a points table 112b, an annotation table 112c and a transformation table 112d while the polygons only database schema 113 may include a panorama table 113a, a polygon table 113b, an annotation table 113c, and a transformation table 113d, while the points and polygons database schema 114 may include a panorama table 114a, a polygon table 114b, an annotation table 114c, a points table 114d and a transformation table 114e wherein the panorama tables, the annotation tables, the polygon tables and the transformation tables contain the same data. The points table 114d for the points and polygons schema contains the location of each point using typical Cartesian three dimensional coordinates (X,Y,Z) while the points tables 112b for the points only schema contains the location of each point using typical spherical coordinates expressed in distance (ρ), zenith (φ) and azimuth (θ).

FIG. 4A is a flow diagram depicting a method 120 to transform a text string representing a standard street address (an address string 121) into a two or three dimensional coordinate that is part of the server process 108a shown in FIG. 2 with an example of the client results shown in FIG. 10B. In the exemplary embodiment shown in FIG. 4A, the method is performed by the server processes 108 in a client/server architecture, but can be performed by other processes such as a processes on a stand-alone computer or processes in a peer-to-peer system. In the methods shown in FIGS. 3-8, the processes, databases and engines shown each may be implemented using one or more lines of computer code wherein a processing unit executes these lines of computer code in order to perform the functions and operations described below. In this method, the user has entered an address string into the text box process shown in FIG. 2. The address string may be passed to an address geocoder 122 that may reside on the primary server or another secondary server. The address geocoder contains a database with a plurality of address strings and the corresponding geo-location coordinate for each address string. If a valid address in the geocoding database is found, the address geocoder 122 returns a two dimensional coordinate value 124 that is used to construct a nearest neighbor query 126 on the spatial database 110 to return a result set of points 128. The result set may include zero, one or more points that fall within the search radius. If the result set is comprised of more than one point a coordinate interpolation process 130 may be used to produce a valid coordinate 132 from the surrounding points that may be fed into the process 108d that is described in more detail with reference to FIG. 7. If there is not a match in the geocoding database, that result is fed into the process 108d. For example, an address string 121 search for “1 Embarcadero St, San Francisco, Calif.” would return the coordinates 37.792228°-122.390781° from the address geo-coding process 122. These coordinates are then used as the basis for the nearest neighbor query within a given range, for example 200 feet. In this example 6 panoramas fall within this range, they are processed by distance and the closest panorama to the address coordinate is loaded and orientated to display the address in the center of the panoramic image viewer.

FIG. 4B is a flow diagram depicting a method 140 to transform a text string 142 representing a descriptive keyword into a three dimensional coordinate that is also part of the server process 108a shown in FIG. 2. In the exemplary embodiment shown in FIG. 4B, the method is performed by the server processes 108 in a client/server architecture, but can be performed by other processes such as a processes on a stand-alone computer or processes in a peer-to-peer system. In this method, the user has entered a keyword into the text box process shown in FIG. 2. In the method, the text string 142 with a descriptive keyword is fed to a keyword query engine 144 that converts the descriptive keyword into a keyword query and the keyword query is applied to the spatial database 110 to generate a keyword result set 146 that is returned to the user as a selectable list as discussed further in the process 108d depicted in FIG. 7. If no result is found from the keyword query, then no result set is passed onto the process 108d. For example, a keyword search for “park” returns seven (7) entries containing “park” in the keyword field. These are processed by distance from the position of the currently loaded panorama. If the tagged item is visible in the current panorama it is rotated to view the tagged item so it is centered within the panoramic image viewer. If the closest tagged item is not visible within the current panorama, the closes panorama in the database will be loaded and oriented to display this item. Now, the process 108b shown in FIG. 2 is described in more detail with reference to FIGS. 5A-D.

FIG. 5A is a flow diagram depicting a method 150 to transform a two dimensional spherical coordinate obtained from a user selected point in the panorama into a three dimensional coordinate utilizing a plurality of three dimensional points contained within the spatial database that is part of the server process 108b shown in FIG. 2. In the exemplary embodiment shown in FIG. 5A, the method is performed by the server processes 108 in a client/server architecture, but can be performed by other processes such as a processes on a stand-alone computer or processes in a peer-to-peer system. In this method, the point data is stored in a three dimensional spherical coordinate system (see FIG. 3B) sharing the same origin as the current panoramic image. User selections in the panoramic image are expressed as two dimension spherical coordinates which are used to structure a nearest neighbor query 126 within a given search range to return three dimensional points contained within the spatial database 110 as the result set 128. These points are in a three dimensional spherical coordinate system (see FIG. 3B) relative to the spatially coincident scanner/panoramic image origin. Because the panoramic image and point data were collected from the same perspective there are no anomalous occlusions present in the point data and hence no occlusion testing is need. Depending on the number of results in the result set, two possible outcomes are present. In a first outcome, if one point is returned, the closest three dimensional point in the database is returned to the client. In a second outcome, if three or more points are returned from the query, a coordinate interpolator 130 is used to interpolate a result based on the returned values. A resulting valid spherical coordinate 152 is then transformed using a coordinate transformation process 154 into a global Cartesian coordinate system. The resulting valid Cartesian coordinate 156 is fed to the process 108d described below in more detail with reference to FIG. 7 (which may be performed on the client in the exemplary embodiment).

FIG. 5B is a flow diagram depicting an alternate method 160 to transform a two dimensional spherical coordinate obtained from a user selected point in the panorama into a three dimensional coordinate utilizing a plurality of three dimensional points contained within the spatial database that is part of the server process 108b shown in FIG. 2. In the exemplary embodiment shown in FIG. 5B, the method is performed by the server processes 108 in a client/server architecture, but can be performed by other processes such as processes on a stand-alone computer or processes in a peer-to-peer system. In this method, the point data is stored in a three dimensional Cartesian coordinate system (see FIG. 3A). In this method, a user selected two dimensional spherical coordinate is used to construct a bounding volume 162 of which the centroid of one end is located at the center of the current viewpoint and whose orientation is defined by the user selected point in the panoramic image. The length of the bounding volume is a default value. A bounding volume query 164 is then executed to determine the points contained within the volume on the spatial database 110. A result set 166 from this bounding volume query is then processed for coordinate validation 168 where the normal of the closest point to the current viewpoint (defined by the center of the current panoramic image) is tested for surface normality. If the normal of the closest returned point is facing the current viewpoint, it is assumed to be visible from the current viewpoint and will produce a valid coordinate 170 which is fed to the process 108d described in more detail in FIG. 7. If the normal of the returned point is not facing the observation point of the panoramic image then it is assumed that additional occlusions exist that are not present in the point or polygon data, an invalid coordinate 172 is returned.

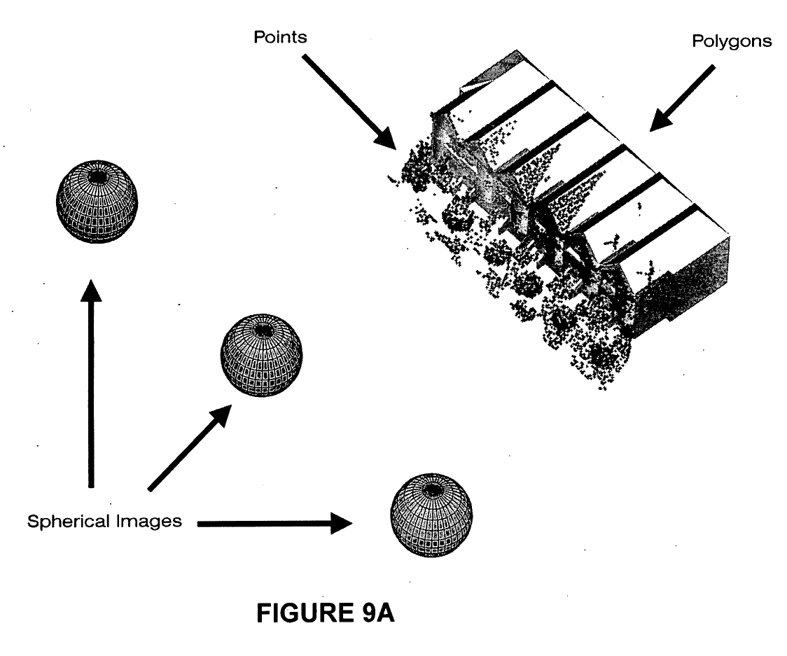

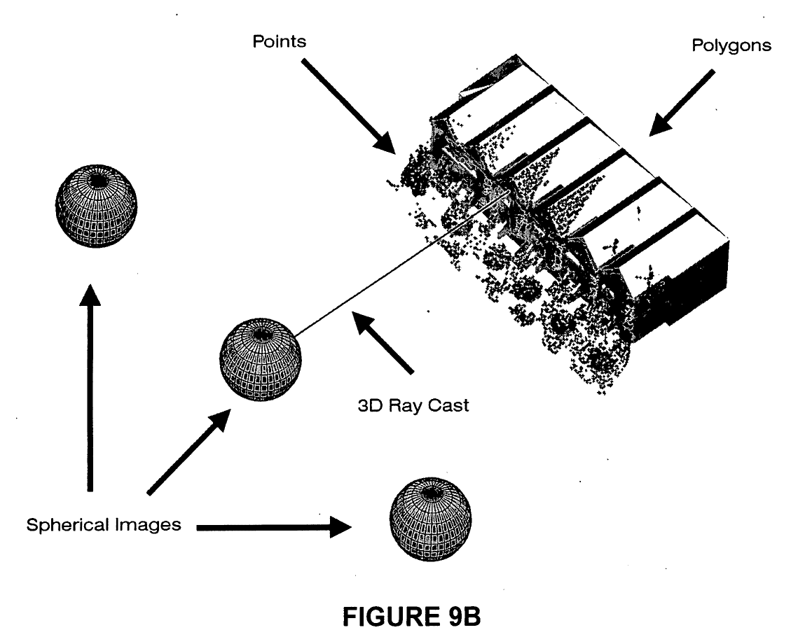

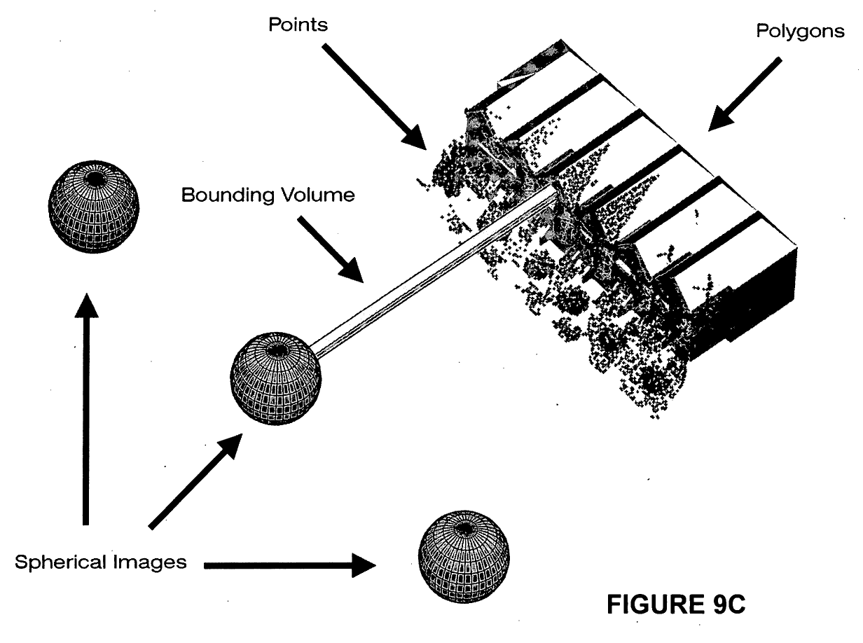

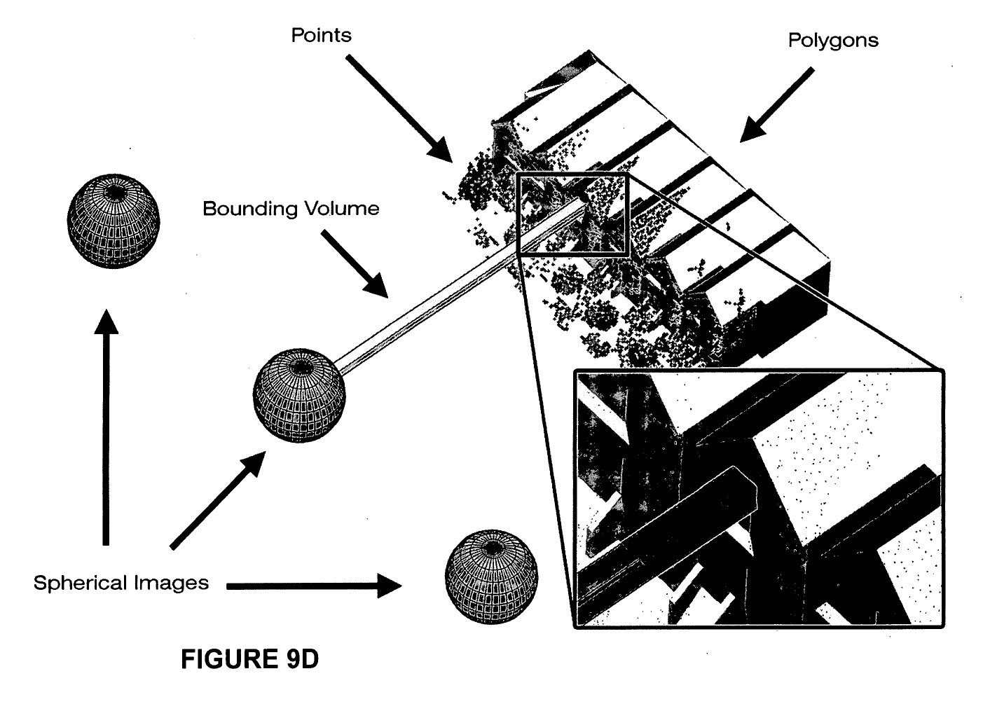

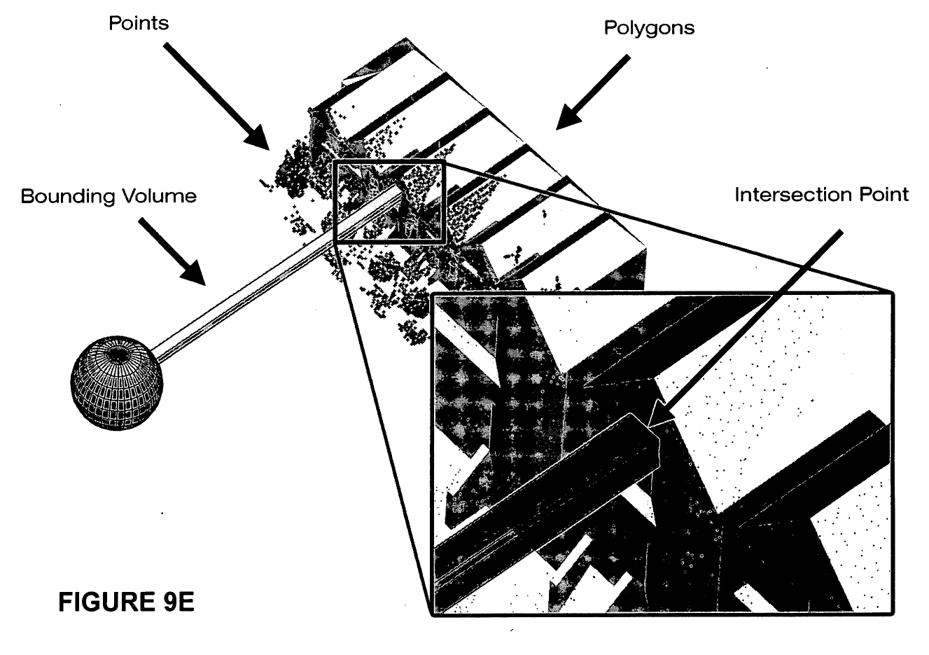

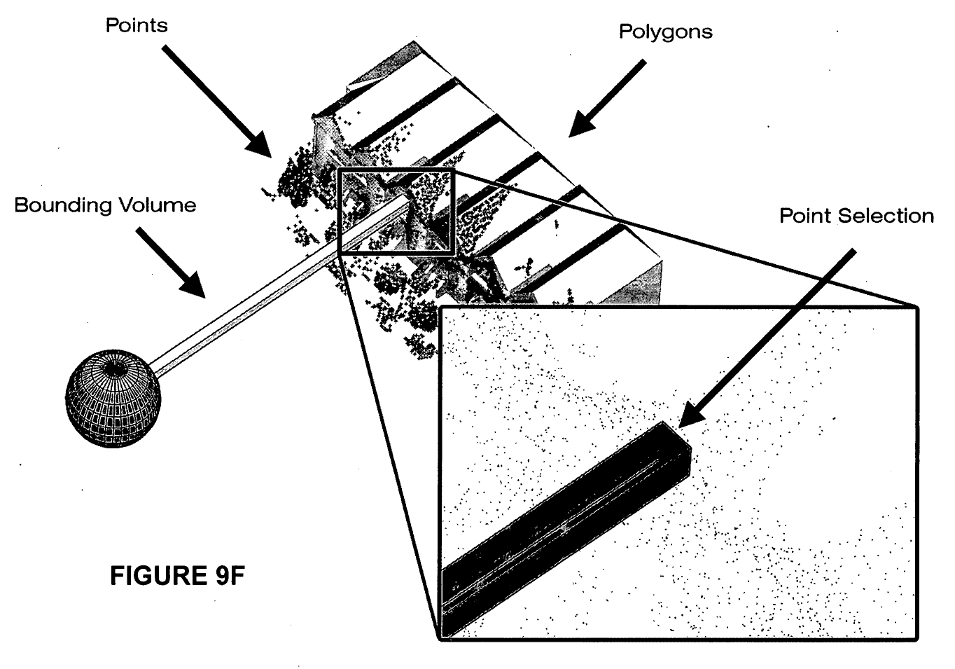

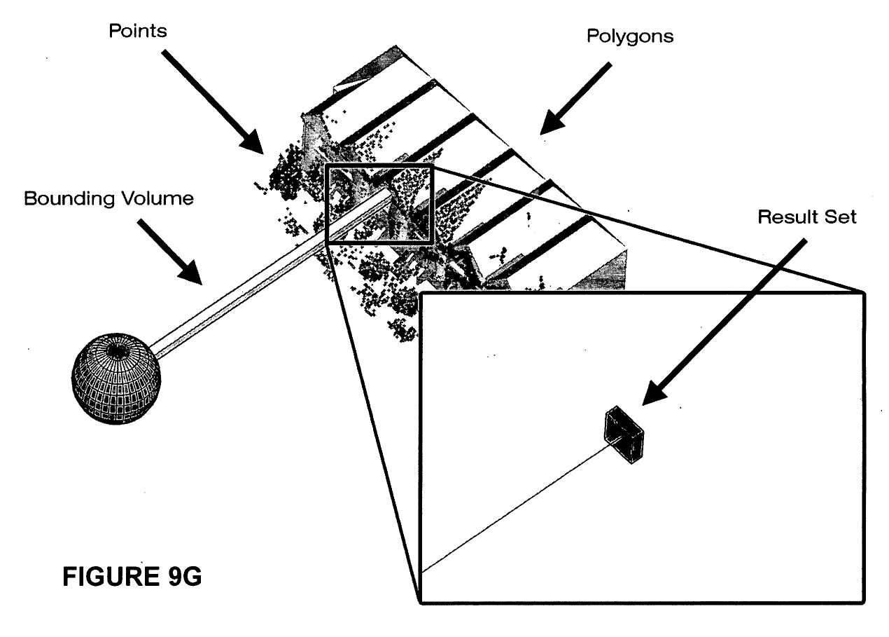

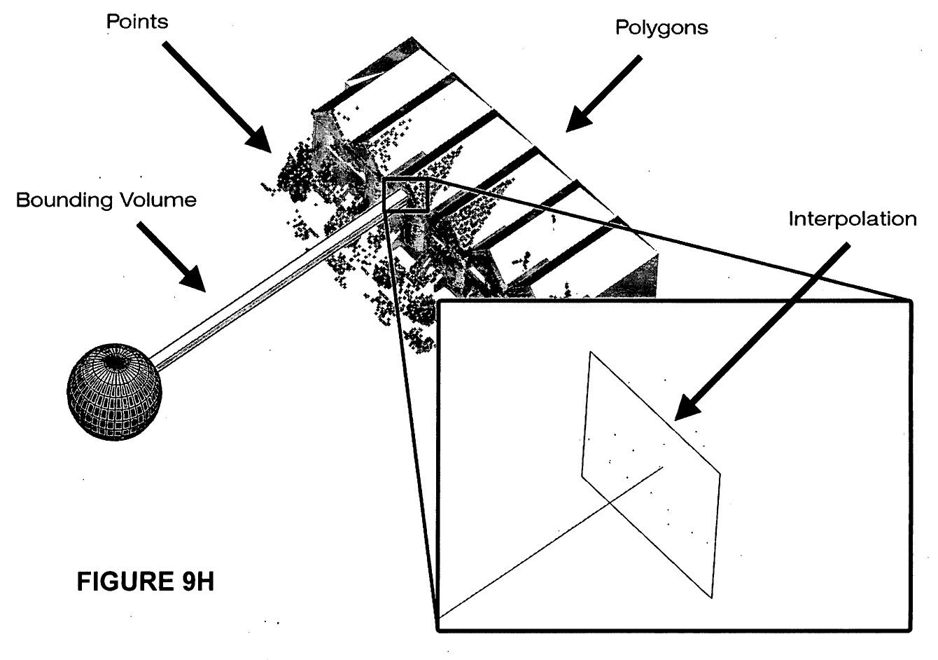

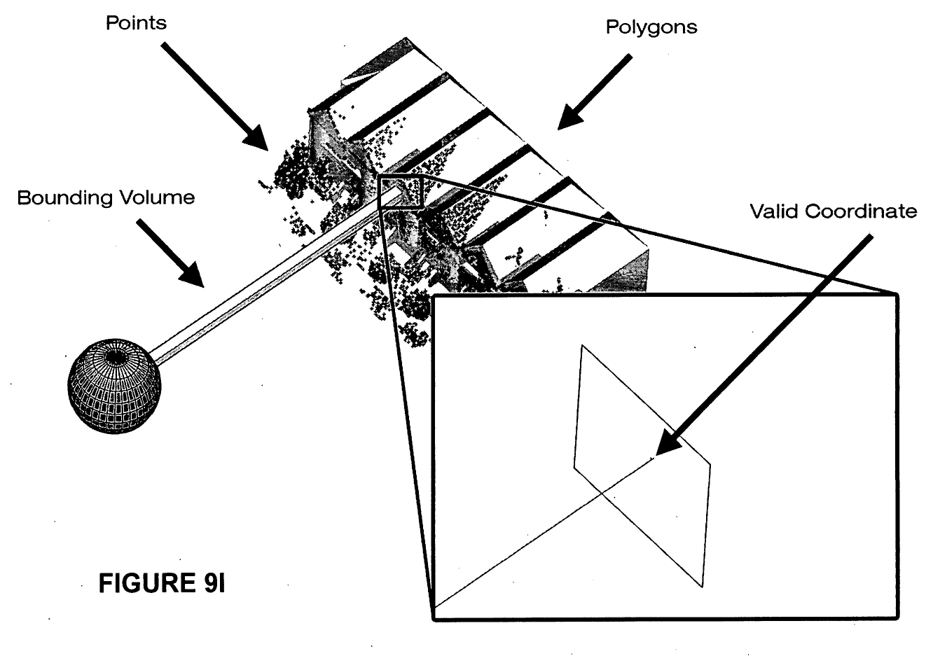

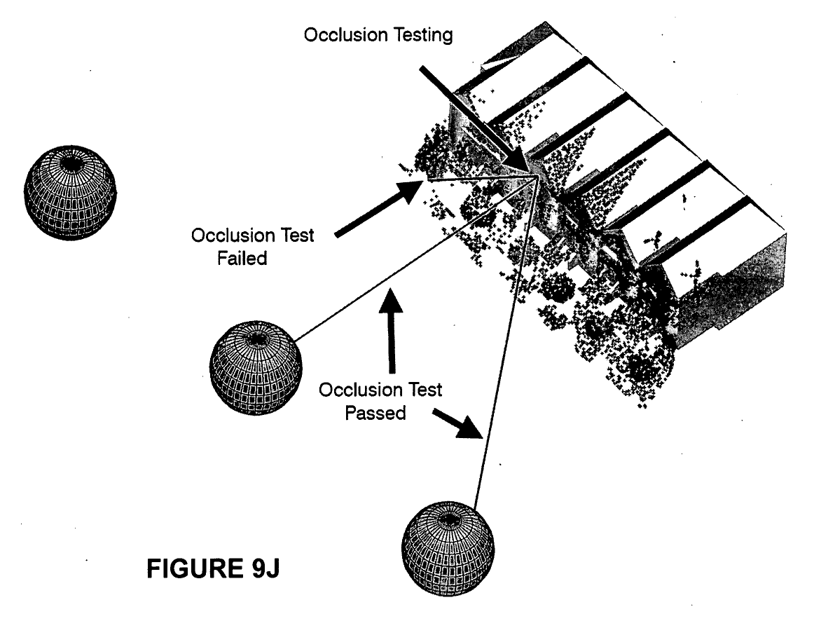

FIG. 5C is a flow diagram depicting a second alternate method 180 to transform a two dimensional spherical coordinate obtained from a user selected point in the panorama into a three dimensional coordinate utilizing a three dimensional surface model contained within the spatial database that is part of the server process 108b shown in FIG. 2. In the exemplary embodiment shown in FIG. 5C, the method is performed by the server processes 108 in a client/server architecture, but can be performed by other processes such as a processes on a stand-alone computer or processes in a peer-to-peer system. In this method, polygons contained in the spatial database are used. In this method, the two dimensional spherical coordinate obtained from the user selection in the panoramic image is used in a well known ray casting process 175 to test for an intersection point on the surface of a polygon contained in the spatial database. An example of this process is shown in FIGS. 9A-9I and in particular FIG. 9B that are described below in more detail. This is done by computing the intersection of the ray defined by the user selection which extends from the panoramic image center to a point on the surface of the polygon as shown in FIG. 9B to generate an intersection point 176. If an intersection point is returned from the ray casting process, the intersection point is expressed in the three dimensional global Cartesian coordinate system. A coordinate validation process 177 then tests for the normal direction of the surface and if this indicates that the surface would be visible from the location, a valid coordinate 178 is produced that is passed onto the process 108d described below in more detail. If the coordinate validation indicates the surface would not be visible, an invalid coordinate 179 will be produced.

FIG. 5D is a flow diagram depicting an alternate method 181 to transform a two dimensional spherical coordinate obtained from a user selected point in the panorama into a three dimensional coordinate utilizing a plurality of three dimensional points and a three dimensional surface model contained within the spatial database that is part of the server process 108b shown in FIG. 2. In the exemplary embodiment shown in FIG. 5D, the method is performed by the server processes 108 in a client/server architecture, but can be performed by other processes such as a processes on a stand-alone computer or processes in a peer-to-peer system. In this method, the ray casting process 175 is first utilized to test for the presence of occlusions by computing the intersection of the ray defined by the user selection which extends from the panoramic image center to a point on the surface of a polygon using the spatial database 110. An example of the process is shown in FIG. 9B. If an intersection point 182 is returned from the ray casting process, it is expressed in the three dimensional global Cartesian coordinate system. The range from the panoramic image center to this intersection point is calculated and stored in memory on the server in the exemplary embodiment. The user selected pan and tilt angles and range to the intersection point on the polygon are used to construct a 3D bounding volume 184 of which the centroid of one end is located at the center of the current viewpoint and whose orientation is defined by the user selected point in the computer image an example of which as shown in FIG. 9C. The length of the bounding volume is defined by the range to the intersection point on the polygon or a default range value is used if no intersection point was encountered. The width of the bounding volume is a fixed value, such as 0.10 meters. The parameters of the bounding volume are defined in a global Cartesian coordinate system and to construct a bounding volume query 186 for the spatial database. A result set 188 from this bounding volume query is then processed for coordinate validation 177 where the normal of the closest point to the current viewpoint (defined by the center of the current panoramic image) is tested for surface normality. If the normal of the closest returned point is facing the current viewpoint it is assumed to be visible from the current viewpoint and will produce a valid coordinate 178 (an example is shown in FIG. 9I) that is passed into the process 108d. If the normal of the returned point is not facing the observation point of the panoramic image then it is assumed that additional occlusions exist that are not present in the polygon or point data and an invalid coordinate 179 is returned.

FIG. 6A is a flow diagram depicting a method 190 to transform a two dimensional coordinate obtained from a user selected point in the map viewer into a three dimensional coordinate utilizing a plurality of three dimensional points contained within the spatial database that is part of the server process 108c shown in FIG. 2. In the exemplary embodiment shown in FIG. 6A, the method is performed by the server processes 108 in a client/server architecture, but can be performed by other processes such as a processes on a stand-alone computer or processes in a peer-to-peer system. In this method, the two dimensional Cartesian coordinate obtained from the user map selection is used to construct a nearest neighbor query 126 to be performed on the x and y components of the points stored within the spatial database 110. The result set 128 may include zero, one or more points that fall within the search radius. If the result set is comprised of more than one point, a coordinate interpolation process 130 may be used to produce a valid coordinate 192 from the surrounding points.

FIG. 6B is a flow diagram depicting a method 200 to transform a two dimensional coordinate obtained from a user selected point in the map viewer into a three dimensional coordinate utilizing a plurality of three dimensional polygons contained within the spatial database that is part of the server process 108c shown in FIG. 2. In the exemplary embodiment shown in FIG. 6B, the method is performed by the server processes 108 in a client/server architecture, but can be performed by other processes such as a processes on a stand-alone computer or processes in a peer-to-peer system. In this method, the two dimensional coordinate obtained from the user selection on the map is used in the ray casting process 175 to test for an intersection point 202 on the surface of a polygon contained in the spatial database 110. This is done by computing the intersection of the ray defined by the user selection which extends from the selection point to a point on the surface the first intersected polygon. If an intersection point is returned from the ray casting algorithm it is expressed in the three dimensional global Cartesian coordinate system. The coordinate validation process 177 then tests for the normal direction of the surface and if this indicates that the surface would be visible from the location a valid coordinate 178 is produced that is passed onto the process 108d described below. If the coordinate validation indicates the surface would not be visible an invalid coordinate 179 will be produced.

FIG. 6C is a flow diagram depicting a method 210 to transform a two dimensional coordinate obtained from a user selected point in the map viewer into a three dimensional coordinate utilizing a plurality of three dimensional points and polygons contained within the spatial database that is part of the server process 108c shown in FIG. 2. In the exemplary embodiment shown in FIG. 6C, the method is performed by the server processes 108 in a client/server architecture, but can be performed by other processes such as a processes on a stand-alone computer or processes in a peer-to-peer system. In this method, the ray casting method 175 is first utilized to test for the presence of occlusions by computing the intersection of the ray defined by the user selection to a point on the surface of the first intersected polygon. If the intersection point 182 is returned from the ray casting method it is expressed in the three dimensional global Cartesian coordinate system. The user selected point and intersection point on the polygon are used to construct a bounding volume 184. The length of the bounding volume is defined by the range to the intersection point on the polygon or a default range value is used if no intersection point was encountered. The width of the bounding volume is a fixed value such as 0.10 meters. The parameters of the bounding volume are defined in a global Cartesian coordinate system and used to construct the bounding volume query 186 of the spatial database 110. The result set 188 from this bounding volume query is then processed for coordinate validation 177 where the normal of the closest point to the current viewpoint (defined by the center of the current panoramic image) is tested for surface normality. If the normal of the closest returned point is facing the current viewpoint it is assumed to be visible from the current viewpoint and will produce a valid coordinate 178 that is passed onto the process 108d. If the normal of the returned point is not facing the observation point of the panoramic image then it is assumed that additional occlusions exist that are not present in the polygon or point data and an invalid coordinate 179 is returned.

FIG. 7A is a flow diagram depicting the processes required to produce the necessary update parameters 227 to pass to a set of client side processes 106d to alter the view of the panoramic imager viewer, map viewer, return reverse geo-coding information and relevant tags based on the user selected location that is part of the process 108d shown in FIG. 2. In the exemplary embodiment shown in FIG. 7A, the method is performed by the server processes 108 in a client/server architecture, but can be performed by other processes such as a processes on a stand-alone computer or processes in a peer-to-peer system.

In the first process 223, depicted in FIG. 7B, the three dimensional coordinate 222 is also used to update the current image in the map viewer as shown in FIG. 7B. The three dimensional coordinate is sent to a web map server 232 which generates the appropriate map images 233 and centers the current view point to the three dimensional coordinate which is returned to the process 106d. An image overlay may be used to reflect the location of this point on the map.

In the second process 224, depicted in FIG. 7C, a three dimensional coordinate 222 obtained from the above processes shown in FIGS. 5A-D and 6A-C is used as the basis for a nearest neighbor query 240 that is performed on a table in the spatial database 110 containing a list of panoramic images and their locations in a three dimensional Cartesian coordinate system. A result set 241 consisting of a set of panoramas within the search range is returned. The result set is then ordered by distance and tested for occlusions using an occlusion test process 242 depicted in FIG. 9F to determine the closest visible panorama 243. An orientation calculation 244 is then performed to get the correct orientation parameters for the panorama so that the part of the panorama displaying the user selection is displayed in the panoramic image viewer. These panorama parameters 245 are then passed back over the network to the client side processes 106d to update the panoramic image viewer. If the three dimensional coordinate is visible from the current panorama, the panorama will be oriented and a graphical marker overlaid on top of the image reflecting the location of the three dimensional coordinate in the two dimensional spherical coordinate system of the panorama. If the returned coordinate is not visible from the current panorama, the closest visible panorama will be loaded into the viewer and oriented correctly to display the point. A list of alternate viewpoints may also be delivered to the client.

In the third process 224, depicted in FIG. 7D, the three dimensional coordinate 222 is sent to a reverse geo-coding 250 process to retrieve a standardized address string 251 reflecting the nearest standard street address to the user selected point. The reverse geo-coder may reside on the primary server or another secondary server. In the fourth process 225, depicted in FIG. 7E, a three dimensional coordinate 222 is used to structure a nearest neighbor query 261 on the tags tables in the spatial database 110 to retrieve a result set 261 containing tags that are within a given range (for example 50 feet) of the user selected point.

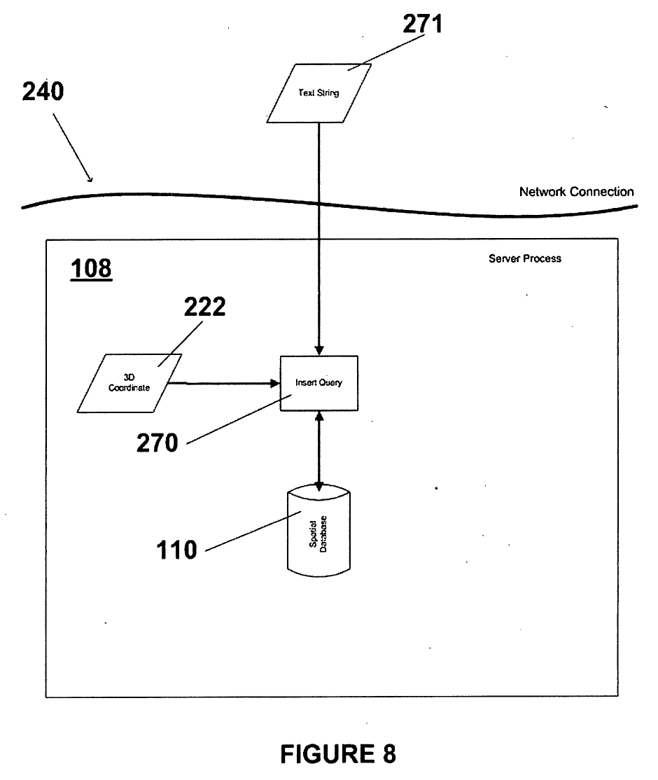

FIG. 8 is a flow diagram depicting a method for user entered tags to be attached to a three dimensional coordinate and saved to the spatial database. In the exemplary embodiment shown in FIG. 8, the method is performed by the server processes 108 in a client/server architecture, but can be performed by other processes such as processes on a stand-alone computer or processes in a peer-to-peer system. In this method, once a valid three dimensional coordinate 222 has been received by the server process 108, the user may enter a text string 271 which may include descriptive text or hyperlinks that reference the user selected point. This text string is then sent to the server process and compiled into an insert query 270. The text string 271 and corresponding three dimensional coordinate are saved to a table containing tags in the spatial database 110.

In the exemplary embodiment these tags may be used by users to communicate information about objects located in the real world that are depicted in the panoramic images and on the map. In one scenario the user may browse using the user interface depicted in FIG. 10A by selecting points in the panorama viewer and map viewer to visually explore the environment. In this browsing scenario the user may find something of interest, for example, a restaurant by visually locating it in a panoramic image. By clicking on the part of the image depicting the restaurant the user may obtain information related to the restaurant utilizing the processes described in FIG. 7D and FIG. 7E. The user will be able to obtain a standardized street address relating to the selected location as well as be able to view tags entered by other users that may contain descriptive information about the restaurant such as a review or include links such as the website of the restaurant.

In another scenario the user may want to search by the name or the address of the restaurant. By inputting the address in the text box 284, the system utilizes an address geo-coding processes described in FIG. 4A to return a three dimensional coordinate and update the panorama viewer and map viewer to display an image depicting the location. A list of tags related to this address, obtained through the process depicted in FIG. 7E, will also be displayed allowing the user to obtain descriptive information entered by other users in the process described in FIG. 8, such as reviews of the restaurant and other information associated with the address. Alternatively the user may enter the name of the restaurant in the text box 284, which will perform the process described in FIG. 4B. If the name of the restaurant is contained within the tag table the search will return a three dimensional coordinate that will be used to update the panorama viewer and map viewer to display an image depicting the location in addition to the result set containing a list of proximate tags obtained using the process depicted in FIG. 7E.

FIGS. 9A-9J depict the process for transforming a two dimensional spherical coordinate obtained from a user selected point in the panorama into a three dimensional coordinate utilizing a three dimensional surface model. FIG. 9A depicts one or more spherical images and a set of points and polygons from the spatial database while FIG. 9B illustrates the ray casting process from a particular spherical image (the one selected by the user) to the spatial database. FIG. 9 illustrates a bounding volume being generated around the intersection point of the ray casting process with the spatial database and FIGS. 9D-E illustrate the details of the intersection of the bounding volume points with the spatial database. FIG. 9F illustrates the selection of a point in the bounding volume and FIG. 9G illustrates the resultant result set. FIG. 9H illustrates the interpolation process over the points in the result set (when the result set contains more than one point) and FIG. 9I illustrates a valid coordinate that is chosen within the result set as a result of the interpolation process. FIG. 9J illustrates the occlusion testing process to determine if a coordinate is visible from a particular panorama location. A user selected three dimensional coordinate from one panoramic image from the previous process FIG. 9A-J is then tested for point(s) and polygons with conflicting normal's through a ray casting algorithm to determine if the user selected coordinate is visible from another panoramic image location. If the user selected coordinate passes/fails the occlusion test for a nearby panoramic image location it is determined to be visible/not visible for that location.

FIG. 10A depicts a web browser interface 280 consisting of a text box 284, map viewer 282, current panorama view location 283 and panorama viewer 281. FIG. 10B illustrates how entering information into one of the windows displays results in all windows. In the panoramic viewer, the user can rotate his/her point of view so that the image currently seen in the panoramic view changes as the user changes the point of view. In addition, each panoramic image shown in the panoramic viewer may be a smart panoramic image in that each point in the image may have various pieces of data associated with that point in the image. For example, in the panoramic image shown in FIG. 10A, the user may click on the motorcycle and enter information into the database so that that information can later be searched by other users or the same user. In this example, user entered information in the text box 290 is sent to the server side address geo-coder 122 and keyword geo-coder 144 returning a three-dimensional coordinate which displays in the map viewer 292 and the panorama viewer 291. User clicks in the panorama viewer are sent to the server side and translated into a three dimensional coordinate depicted in FIGS. 5A-D and a reverse geo-coding process depicted in FIG. 7D with the resulting coordinate displayed in the map viewer 292 and address displayed in the text box 290 respectively. User clicks in the map viewer 292 are sent to the server side and converted into a three dimensional coordinate using processes depicted in FIG. 6A-C where it is then passed through a reverse geo-coder process depicted in FIG. 7D to obtain a standardized street address. The information is also used to update the current image in the panoramic image viewer using process depicted in FIG. 7C and return a standardized street address through the reverse geo-coding process depicted in FIG. 7D with the address displayed in the text box 290.

While the foregoing has been with reference to a particular embodiment of the invention, it will be appreciated by those skilled in the art that changes in this embodiment may be made without departing from the principles and spirit of the invention, the scope of which is defined by the appended claims.

1. A system for the transmission of three dimensional data over a network, comprising:
a first computing device having a panoramic image viewer containing a plurality of panoramic two dimensional images;
a second computing device capable of communicating with the first computing device over a network, the second computing device further comprising a spatial database having a plurality of pieces of three dimensional data; and
wherein the second computing device further comprises a transformation process that transforms a user selected two dimensional point in the panoramic image viewer into a set of three dimensional points based on the spatial database and the three dimensional points are returned to the panoramic image viewer.

2. The system of claim 1, wherein the first computing device is a client computer and the second computing device is a server computer.

3. The system of claim 2, wherein the client computer further comprises a laptop computer, a desktop computer, a PDA such as a Palm device, a wireless email device such as the Blackberry, a mobile phone device or a tablet computer.

4. The system of claim 1, wherein the first and second computing devices both comprise a stand-alone computer wherein the network further comprises a bus in the stand-alone computer.

5. The system of claim 1, wherein the first computing device further comprises a first peer computer and the second computing device further comprises a second peer computer and wherein the network further comprises a peer-to-peer network between the first and second computing devices.

6. The system of claim 1, wherein the spatial database further comprises a plurality of points wherein each point is stored in a three dimensional spherical coordinate system.

7. The system of claim 1, wherein the spatial database further comprises a plurality of points wherein each point is stored in a three dimensional Cartesian coordinate system.

8. The system of claim 7, wherein the spatial database further comprises a plurality of polygons associated with the plurality of points wherein each polygon is stored in a three dimensional Cartesian coordinate system.

9. The system of claim 1, wherein the spatial database further comprises a plurality of polygons wherein each polygon is stored in a three dimensional Cartesian coordinate system.

10. The system of claim 1, wherein the panoramic image viewer further comprises a map viewer that enables a user of the first computing device to see an image of a given area on a map and make selections on that map.

11. The system of claim 10, wherein the spatial database further comprises a plurality of points wherein each point is stored in a three dimensional Cartesian coordinate system.

12. The system of claim 10, wherein the spatial database further comprises a plurality of polygons wherein each polygon is stored in a three dimensional Cartesian coordinate system.

13. The system of claim 12, wherein the spatial database further comprises a plurality of points associated with the plurality of polygons and wherein each point is stored in a three dimensional Cartesian coordinate system.

14. A method for the transmission of three dimensional data over a network using a first computing device having a panoramic image viewer containing a plurality of panoramic two dimensional images and a second computing device capable of communicating with the first computing device over a network, the second computing device further comprising a spatial database having a plurality of pieces of three dimensional data, the method comprising:
receiving a user selected two dimensional point from a panoramic image viewer executed on the first computing device;
querying a spatial database based on the user selected two dimensional point to generate a set of three dimensional points based on the spatial database; and
returning the set of three dimensional points back to panoramic image viewer.

15. The method of claim 14 further comprising storing a plurality of points in the spatial database wherein each point is stored in a three dimensional spherical coordinate method.

16. The method of claim 14 further comprising storing a plurality of points in the spatial database wherein each point is stored in a three dimensional Cartesian coordinate method.

17. The method of claim 16 further comprising storing a plurality of polygons in the spatial database wherein each polygon is stored in a three dimensional Cartesian coordinate method.

18. The method of claim 14 further comprising storing a plurality of polygons in the spatial database wherein each polygon is stored in a three dimensional Cartesian coordinate method.

19. The method of claim 14 further comprising displaying in a map viewer a map of a given area and selecting the user selected two dimensional point using the map viewer.

20. The method of claim 19 further comprising storing a plurality of points in the spatial database wherein each point is stored in a three dimensional Cartesian coordinate method.

21. The method of claim 19, further comprising storing a plurality of polygons in the spatial database wherein each polygon is stored in a three dimensional Cartesian coordinate method.

22. The method of claim 21, further comprising storing a plurality of points associated with the plurality of polygons and wherein each point is stored in a three dimensional Cartesian coordinate method.

23. A method for viewing geocoded data, comprising:
viewing a panoramic image;
selecting a point in the panoramic image; and
viewing a set of geocoded data associated with the selected point in the panoramic image.

24. The method of claim 23, wherein the geocoded data further comprises geocoded two dimensional data.

25. The method of claim 23, wherein the geocoded data further comprises geocoded three dimensional data.

26. The method of claim 24, wherein the geocoded two dimensional data further comprises geocoded address information.

27. The method of claim 26, wherein the geocoded address information further comprises at least a point, a line or a polygon.
